(19) United States
(12) Patent Application Publication
(10) Pub. No.: US 2026/0247389 A1
(43) Pub. Date: Aug. 20, 2026

(54) PHYSICAL UPLINK SHARED CHANNEL COMMUNICATION METHOD AND APPARATUS, AND STORAGE MEDIUM

(71) Applicant: BEIJING XIAOMI MOBILE SOFTWARE CO., LTD., Beijing (CN)

(72) Inventor: Xueyuan GAO, Beijing (CN)

(73) Assignee: BEIJING XIAOMI MOBILE SOFTWARE CO., LTD., Beijing (CN)

(21) Appl. No.: 19/161,777

(22) PCT Filed: Mar. 3, 2023
(86) PCT No.: PCT/CN2023/079693

§ 371 Date: Sep. 3, 2025

(51) Int. Cl. H04W 72/21

(52) U.S. Cl. CPC H04W 72/21

(57) ABSTRACT

A method for a PUSCH communication and an apparatus for a PUSCH communication are provided. The method includes: determining that a transmission configuration of the terminal is an uplink M-TRP transmission configuration, and receiving first information, where the first information is used to configure a transmission scheme and a transmission waveform corresponding to a PUSCH in an M-TRP transmission; and performing the PUSCH communication according to the transmission scheme and the transmission waveform configured by the first information.

### CROSS-REFERENCE TO RELATED APPLICATIONS

The present application is a U.S. National Phase of International Application No. PCT/CN2023/079693, filed on Mar. 3, 2023, the entire content of which is incorporated herein by reference for all purposes.

### FIELD

The present disclosure relates to the field of communication technologies, and in particular relates to a method and an apparatus for a physical uplink shared channel (PUSCH) communication, and a storage medium.

### BACKGROUND

In the related art, an uplink transmission on a physical uplink shared channel (PUSCH) may support two kinds of waveforms: a cyclic prefix-orthogonal frequency division multiplexing (CP-OFDM) waveform and a discrete Fourier transform-spread-orthogonal frequency division multiplexing (DFT-S-OFDM) waveform. Further, the PUSCH may further support a space division multiplexing (SDM) scheme or a single frequency network (SFN) scheme.

An uplink enhancement of Rel-18 of a new radio (NR) of the 3rd generation partnership project (3GPP) aims to support higher uplink throughput and more reliable transmission performance through an uplink simultaneous transmission enhancement via multi-panel/multi-transmission reception point (M-TRP).

At present, in a simultaneous transmission via multi-panel (STxMP), how to instruct these waveforms, switching of waveforms, transmission schemes and switching of transmission schemes is a problem to be solved.

### SUMMARY

According to a first aspect of embodiments of the present disclosure, a method for a PUSCH communication is provided, performed by a terminal, including:
determining that a transmission configuration of the terminal is an uplink multiple-transmission reception point (M-TRP) transmission configuration, and receiving first information, in which the first information is used to configure a transmission scheme and a transmission waveform corresponding to a PUSCH in an M-TRP transmission; and
performing the PUSCH communication according to the transmission scheme and the transmission waveform configured by the first information.

According to a second aspect of embodiments of the present disclosure, a method for a PUSCH communication is provided, performed by a network device, including:
determining that a transmission configuration of a terminal is an uplink M-TRP transmission configuration, and sending first information, in which the first information is used to configure a transmission scheme and a transmission waveform corresponding to a PUSCH in an M-TRP transmission; and
performing the PUSCH communication according to the transmission scheme and the transmission waveform configured by the first information.

According to a third aspect of embodiments of the present disclosure, there is provided an apparatus for a PUSCH communication, including:
a receiving unit configured to determine that a transmission configuration of the terminal is an uplink M-TRP transmission configuration, and receive first information, in which the first information is used to configure a transmission scheme and a transmission waveform corresponding to a PUSCH in an M-TRP transmission; and
a communicating unit configured to perform the PUSCH communication according to the transmission scheme and the transmission waveform configured by the first information.

According to a fourth aspect of embodiments of the present disclosure, there is provided an apparatus for a PUSCH communication, including:
a sending unit configured to determine that a transmission configuration of a terminal is an uplink M-TRP transmission configuration, and send first information, in which the first information is used to configure a transmission scheme and a transmission waveform corresponding to a PUSCH in an M-TRP transmission; and
a communicating unit configured to perform the PUSCH communication according to the transmission scheme and the transmission waveform configured by the first information.

According to a fifth aspect of embodiments of the present disclosure, there is provided a device for a PUSCH communication, including:
a processor; and
a memory for storing processor-executable instructions;
in which the processor is configured to perform the method as described in the first aspect or any one of embodiments of the first aspect, or perform the method as described in the second aspect or any one of embodiments of the second aspect.

According to a sixth aspect of embodiments of the present disclosure, there is provided a storage medium having stored therein instructions that, when executed by a processor of a first device, enable the first device to perform the method as described in the first aspect or any one of embodiments of the first aspect; and when executed by a processor of a second device, enable the second device to perform the method as described in the second aspect or any one of embodiments of the second aspect.

It is to be understood that both the foregoing general description and the following detailed description are illustrative and explanatory only and are not restrictive of the disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a schematic diagram illustrating a wireless communication system according to an illustrative embodiment.

FIG. 2 is a schematic diagram illustrating a multiple-transmission reception point (M-TRP) transmission method in a single-downlink control information (S-DCI) scheduling according to an illustrative embodiment.

FIG. 3 is a schematic diagram illustrating an M-TRP transmission method in a multiple-downlink control information (M-DCI) scheduling according to an illustrative embodiment.

FIG. 4 is a flow chart illustrating a method for a physical uplink shared channel (PUSCH) communication according to an illustrative embodiment.

FIG. 5 is a flow chart illustrating a method for a PUSCH communication according to an illustrative embodiment.

FIG. 6 is a flow chart illustrating a method for a PUSCH communication according to an illustrative embodiment.

FIG. 7 is a flow chart illustrating a method for a PUSCH communication according to an illustrative embodiment.

FIG. 8 is a flow chart illustrating a method for a PUSCH communication according to an illustrative embodiment.

FIG. 9 is a flow chart illustrating a method for a PUSCH communication according to an illustrative embodiment.

FIG. 10 is a flow chart illustrating a method for a PUSCH communication according to an illustrative embodiment.

FIG. 11 is a flow chart illustrating a method for a PUSCH communication according to an illustrative embodiment.

FIG. 12 is a block diagram illustrating an apparatus for a PUSCH communication according to an illustrative embodiment.

FIG. 13 is a block diagram illustrating an apparatus for a PUSCH communication according to an illustrative embodiment.

FIG. 14 is a block diagram illustrating a device for a PUSCH communication according to an illustrative embodiment.

FIG. 15 is a block diagram illustrating a device for a PUSCH communication according to an illustrative embodiment.

### DETAILED DESCRIPTION

Reference will now be made in detail to illustrative embodiments, examples of which are illustrated in the accompanying drawings. The following description refers to the accompanying drawings in which the same numbers in different drawings represent the same or similar elements unless otherwise represented. The implementations set forth in the following description of illustrative embodiments do not represent all implementations consistent with the present disclosure.

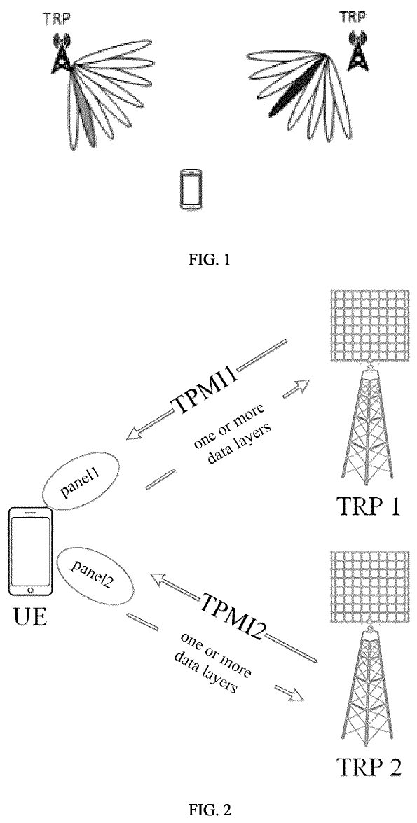

The communication method of the embodiments of the present disclosure may be applied to a wireless communication system illustrated in FIG. 1. Referring to FIG. 1, the wireless communication system includes a network device and a terminal. The terminal is connected to the network device through wireless resources and performs data transmission.

It may be understood that the wireless communication system shown in FIG. 1 is only for schematic illustration. The wireless communication system may also include other network devices, such as core network devices, wireless relay devices, and wireless backhaul devices, which are not shown in FIG. 1. The number of network devices and the number of terminals included in the wireless communication system are not limited in embodiments of the present disclosure.

It may be further understood that the wireless communication system in the embodiments of the present disclosure is a network that provides wireless communication functions. The wireless communication system may employ different communication technologies, such as code division multiple access (CDMA), wideband code division multiple access (WCDMA), time division multiple access (TDMA), frequency division multiple access (FDMA), orthogonal frequency-division multiple access (OFDMA), single carrier frequency division multiple access (SC-FDMA), and carrier sense multiple access with collision avoidance. The network may be divided into a 2nd generation (2G) network, a 3G network, a 4G network, or a future evolution network, such as a 5G network, which may also be referred to as a new radio (NR) network, according to the capacity, rate, delay, and other factors of different networks. For ease of description, a wireless communication network will be sometimes abbreviated as a network in the present disclosure.

Further, the network device involved in the present disclosure may also be referred to as a radio access network device. The radio access network device may be a base station, an evolved node B, a home base station, an access point (AP) in a wireless fidelity (Wi-Fi) system, a wireless relay node, a wireless backhaul node, a transmission point (TP), a transmission and reception point (TRP), or the like, or may also be a generation NodeB (gNB) in an NR system, or may also be a component or a part of a device that constitutes a base station, or the like. It is to be understood that the specific technology and specific device form adopted by the network device are not limited in the embodiments of the present disclosure. In the present disclosure, the network device may provide communication coverage for specific geographic areas and may communicate with terminals located within that coverage area (cell). In addition, when it comes to a vehicle to everything (V2X) communication systems, the network device may also be a vehicle-mounted device.

Further, the terminal involved in the present disclosure, which may also be referred to as a terminal device, a user equipment (UE), a mobile station (MS), a mobile terminal (MT), or the like, is a device that provides voice and/or data connectivity to a user. For example, the terminal may be a handheld device with a wireless connection function, a vehicle-mounted device, or the like. At present, some examples of the terminal are a smart phone, a pocket personal computer (PPC), a palmtop computer, a personal digital assistant (PDA), a notebook computer, a tablet computer, a wearable device, a vehicle-mounted device, or the like. In addition, the terminal device may also be a vehicle-mounted device when it is used in a vehicle to everything (V2X) communication system. It is to be understood that the specific technology and specific device form adopted by the terminal are not limited in the embodiments of the present disclosure.

Regarding uplink PUSCH transmission to directions of multiple TRPs of a base station, Release-17 (R17) mainly standardizes cooperative transmission related to the time division multiplexing (TDM) transmission mode, and same information on the PUSCH is repeatedly sent to different TRPs of the base station in a time division manner through different transmission occasions (TOs) in the time domain. This method has a relatively low requirement on the capability of the terminal, does not require the support of a capability for sending beams simultaneously, and has a large transmission delay.

Regarding the uplink, for PUSCH channels of different TRPs, the actually passed channels may have very different spatial features. Therefore, it is considered that the quasi-co-locations-D (QCL-D) of PUSCH channels in different sending directions are different.

R15/16 does not consider the M-TRP scenario, and the uplink is a single TRP transmission. R17 enhances the M-TRP uplink transmission in a single downlink control information (S-DCI), and the uplink PUSCH transmission is transmitted to the TRP directions of multiple base stations. R17 mainly standardizes cooperative transmission related to the TDM transmission mode, and same information on the PUSCH is repeatedly sent to different TRPs of the base station in a time division manner through different TOs in the time domain. This method has a relatively low requirement on the capability of the terminal, and each TO only needs to send a PUSCH in one TRP direction, thus it does not require the support of a capability for sending beams simultaneously, and has a large transmission delay.

In an enhancement target of R18, it is mainly desirable to achieve simultaneous cooperative transmission through multiple panels of the terminal towards multiple TRP directions to increase the transmission reliability and throughput rate, and may effectively reduce the transmission delay with multiple TRPs, but the terminal is required to have the capability of sending multiple beams simultaneously. Transmission of the PUSCH may be based on transmission from multiple antenna panels to multiple TRPs, scheduled by a single physical downlink control channel (PDCCH), i.e. an S-DCI, as shown in FIG. 2. The UE communicates with a TPR1 of the base station via a panel1, for example, receives a first transmit precoding matrix indicator (TPMI1) sent by the TPR1, and sends one or more pieces of information related to a transport layer to the TRP1, and communicates with a TPR2 of the base station via a panel2, for example, receives a second TPMI2 sent by the TPR2, and sends one or more pieces of information related to the transport layer to the TRP2.

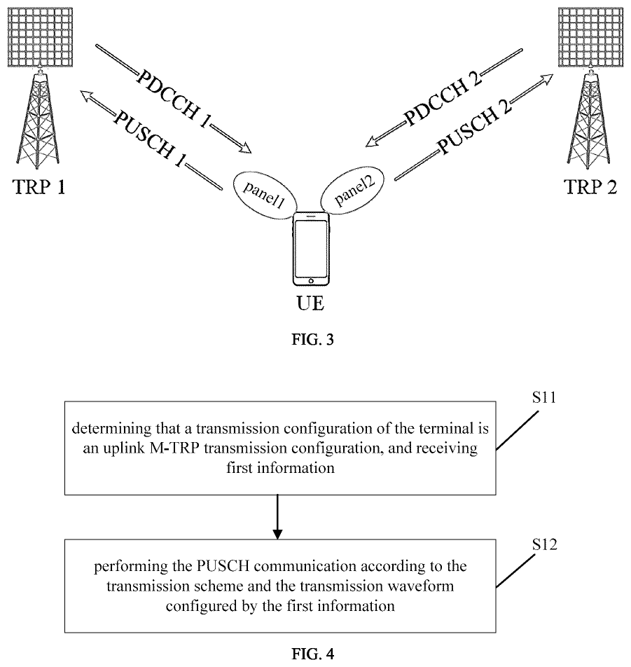

Transmission of the PUSCH may be based on different PDCCHs, i.e., transmission from multiple antenna panels to multiple TRPs scheduled by multi-downlink control information (M-DCI), as shown in FIG. 3. The UE communicates with the TPR1 of the base station via the panel1, receives, for example, a PDCCH1 sent by the TRP1, and sends the PUSCH1 to the TRP1. The UE communicates with the TPR2 of the base station via the panel2, receives, for example, a PDCCH2 sent by the TRP2, and sends the PUSCH2 to the TRP2.

In actual deployment, the link between transmission points may be a relatively ideal backhaul link that supports high throughput and very low backhaul latency, or it may be a non-ideal backhaul link using x digital subscriber line (xDSL), microwave and relay. The non-coherent joint transmission (NC-JT) transmission scheme based on the M-DCI was initially introduced mainly for non-ideal backhaul situations, but this scheme may also be used for ideal backhaul situations.

Terminals are generally configured with multiple physical panels, and different panels may have different capabilities. For example, they have different numbers of sounding reference signal (SRS) ports, and a maximum number of supported data transmission layers may not necessarily be the same. For example, one panel supports up to 2 layers of transmission, and the other panel supports up to 4 layers of transmission. The network scheduler will determine whether the terminal is currently suitable for a simultaneous transmission via multi-panel. If the terminal is currently suitable for the simultaneous transmission via multi-panel and is scheduled simultaneously, the network will directly or indirectly indicate relevant transmission parameters, including the specific beam indication information of the terminal, the number of data layers used for transmission, the port allocation of the demodulation reference signal (DMRS) used, and the precoding indication information.

In an uplink simultaneous transmission from multiple panels (STxMP) of R18, the transmission schemes supported for the PUSCH according to the S-DCI include a space division multiplexing (SDM) scheme and a single frequency network (SFN) scheme. The SDM scheme means that different parts of a transport block (TB) of the PUSCH are respectively sent to two different TRPs on the same time-frequency resource through corresponding DMRS ports or port combinations allocated on different panels, and different panels/TRPs/TOs are respectively associated with different TCI states, that is, beams. The SFN scheme means that one TB of the PUSCH is sent to two different TRPs on the same time-frequency resource through the same DMRS port or port combination allocated on different panels, and different panels/TRPs/TOs are respectively associated with different TCI states, that is, beams.

In a non-codebook and codebook-based M-TRP transmission in R17, an SRS resource indicator (SRI) field in the DCI indicates an SRS resource in an SRS resource set. Since R17 supports two SRS resource sets, in a non-codebook-based M-TRP PUSCH repetition transmission, two SRI fields associated with the two SRS resource sets are included in a DCI format 0_1/0_2, and each SRI field indicates an SRI for one TRP. The design of the first SRI field is based on the framework of R15/16, and all repetitions use the same number of layers.

For a non-codebook-based transmission, a first SRI field is used to determine elements in a second SRI field, and the second SRI field includes only SRI combinations associated with the number of layers indicated by the first SRI field. A number of bits N2 of the second SRI field is determined by a maximum number of code points per rank among all ranks associated with the first SRI field.

In the codebook-based M-TRP PUSCH repetition transmission, two TPMI fields are indicated in the DCI format 0_1/0_2, in which the first TPMI field is designed identically to the TPMI field in R15/16 (including a TPMI index and the number of layers), and the second TPMI field includes only a second TPMI index, and the number of layers thereof is the same as the number of layers indicated by the first TPMI field. The first TPMI field is used to determine elements in the second TPMI field, and the second TPMI field includes only TPMIs associated with the number of layers indicated by the first TPMI field. The number of bits M2 of the second TPMI field is determined by the maximum number of code points per rank among all ranks associated with the first TPMI field. Table 1 shows the correspondence of each code point with the SRS resource set and the SRI field/TPMI field. The indication field for dynamically indicating single-transmission reception point (S-TRP) and M-TRP transmission scheduling is defined as follows: in a single TRP, the first SRI/TPMI field may be associated with any SRS resource.

TABLE 1

| | | SRI (codebook-based or non- |
|---|---|---|
| | | codebook-based transmission)/ |
| Code | | TPMI (codebook-based |
| point | SRS resource set | transmission) field |
| 00 | S-TRP transmission mode, | a first SRI/TPMI field |
| | configuring a first SRS resource | |
| | set (TRP1) | |
| 01 | S-TRP transmission mode, | a first SRI/TPMI field |
| | configuring a second SRS | |
| | resource set (TRP2) | |
| 10 | M-TRP transmission mode (in | a first SRI/TPMI field and a |
| | an order of TRP1 and TRP2) | second SRI/TPMI field |
| | the first SRI/TPMI field | |
| | corresponds to the first SRS | |
| | resource set | |
| | the second SRI/TPMI field | |
| | corresponds to the second SRS | |
| | resource set | |
| 11 | M-TRP transmission mode (in | a first SRI/TPMI field and a |
| | an order of TRP2 and TRP1) | second SRI/TPMI field |
| | the first SRI/TPMI field | |
| | corresponds to the first SRS | |
| | resource set | |
| | the second SRI/TPMI field | |
| | corresponds to the second SRS | |
| | resource set | |

In an implementation of the present disclosure, the simultaneous transmission via multi-panel may be the uplink PUSCH simultaneous transmission according to a cyclic prefix-orthogonal frequency division multiplexing (CP-OFDM) waveform, thereby improving the throughput and efficiency of an uplink of a system. An uplink protocol supports two waveform designs. For the transmission of a discrete Fourier transform-spread-orthogonal frequency division multiplexing (DFT-S-OFDM) waveform, the benefits of low peak-to-average power ratio (PAPR) are considered, which is currently mainly used in a cell edge scenario. With the design of S-DCI, the uplink PUSCH may also support the SDM/SFN transmission scheme, and these two transmission schemes may also obtain gain at a cell edge. Therefore, it is possible to consider enhancing the simultaneous transmission via multi-panel for the DFT-S-OFDM waveform.

In view of this, the embodiments of the present disclosure provides a method for a PUSCH communication. The method is executed by a terminal configured for the uplink multi-TRP transmission. The terminal receives the first information and configures the transmission scheme and the transmission waveform corresponding to the PUSCH in the M-TRP transmission according to the first information. Therefore, a solution for instructing and switching the transmission scheme and the transmission waveform in the STxMP transmission is provided, thereby improving the throughput and efficiency of the uplink of the system.

FIG. 4 is a flow chart illustrating a method for a PUSCH communication according to an illustrative embodiment. As shown in FIG. 4, the method is performed by a terminal and includes the following steps.

In step S11, it is determined that a transmission configuration of the terminal is an uplink M-TRP transmission configuration, and first information is received.

The first information is used to configure a transmission scheme and a transmission waveform corresponding to a PUSCH in an M-TRP transmission.

In step S12, the PUSCH communication is performed according to the transmission scheme and the transmission waveform configured by the first information.

In embodiments of the present disclosure, the terminal is configured for the uplink M-TRP transmission, that is, a network device may configure multiple SRS resource sets for the terminal. The multiple SRS resource sets may correspond to codebook-based uplink M-TRP transmission or non-codebook-based uplink M-TRP transmission.

In embodiments of the present disclosure, the PUSCH may be a dynamic grant (DG) PUSCH or a configured grant (CG) PUSCH.

In embodiments of the present disclosure, in response to determining that the transmission configuration of the terminal is the uplink M-TRP transmission configuration, the terminal may receive the first information, and the first information is used to configure the transmission scheme and the transmission waveform corresponding to the PUSCH in the M-TRP transmission. In an example, the first information may be carried in a radio resource control (RRC) signaling.

In the related art, in a case where the transmission configuration of the terminal is an uplink S-TRP transmission configuration, the transmission scheme corresponding to the PUSCH is indicated by DCI. For example, the DCI may indicate that the transmission scheme corresponding to the PUSCH is an SDM scheme or an SFN scheme, or the DCI may indicate that the transmission scheme corresponding to the PUSCH is switched to the SDM scheme or the SFN scheme. Further, in the related art, the transmission waveform may be configured to be a DFT-s-OFDM waveform by configuring transformPrecoder enabled by the RRC signaling, and the transmission waveform may be configured to be a CP-OFDM waveform disabled by the RRC signaling. As mentioned above, since the DFT-S-OFDM waveform is currently mainly used in a cell edge scenario, and the SDM/SFN transmission scheme may also obtain gain at a cell edge, the transmission scheme and the transmission waveform corresponding to the PUSCH in the M-TRP transmission may be indicated by unified first information. Furthermore, the transmission scheme and the transmission waveform corresponding to the PUSCH in the M-TRP transmission may be indicated by the first information carried in the RRC signaling.

In embodiments of the present disclosure, the terminal may perform the PUSCH communication according to the transmission scheme and the transmission waveform configured by the first information.

By adopting the technical solution of the embodiments of the present disclosure, the terminal receives the first information and configures the transmission scheme and the transmission waveform corresponding to the PUSCH in the M-TRP transmission according to the first information. Therefore, a solution for instructing and switching the transmission scheme and the transmission waveform in the STxMP transmission is provided, thereby improving the throughput and efficiency of the uplink of the system.

In embodiments of the present disclosure, the PUSCH may be scheduled according to the S-DCI or the M-DCI.

In embodiments of the present disclosure, the transmission scheme may include the SDM scheme or the SFN scheme, and the transmission waveform may be the DFT-S-OFDM waveform.

In embodiments of the present disclosure, in response to the transmission scheme including the SDM scheme, the first information is further used to configure a first transmission resource configuration parameter, and the first transmission resource configuration parameter is used to configure one or more panels corresponding to the PUSCH to map to a same time-frequency resource. The first transmission resource configuration parameter includes at least one of: a maximum number of transmission data layers supported by the terminal; or a maximum number of transmission data layers supported by each of the one or more panels corresponding to the PUSCH.

That is, in response to the transmission scheme including the SDM scheme, the maximum number of transmission data layers supported by the terminal or the maximum number of transmission data layers supported by each of the one or more panels corresponding to the PUSCH may be configured according to the first information. The maximum number of transmission data layers supported by each of the one or more panels corresponding to the PUSCH is 1 or 2. The maximum number of transmission data layers supported by the terminal is determined by the product of a number of panels corresponding to the terminal performing the uplink transmission and the maximum number of transmission data layers supported by each panel.

In an example, in a case where the terminal performs the uplink transmission according to two panels, and the maximum number of transmission data layers supported by each panel is 1, the terminal may support an SDM transmission in which the maximum number of transmission data layers is 2, and different panels are mapped to the same time-frequency resource. In another example, in a case where the terminal includes two panels, and the maximum number of transmission data layers supported by each panel is 2, the terminal may support an SDM transmission in which the maximum number of transmission data layers is 4, and different panels are mapped to the same time-frequency resource. In this way, a peak to average power ratio (PAPR) may increase, but the throughput of the system will increase.

In embodiments of the present disclosure, in response to the transmission scheme including the SFN scheme, the first information is further used to configure a second transmission resource configuration parameter. The second transmission resource configuration parameter is used to configure one or more panels corresponding to the PUSCH to map a same number of transmission data layers to a same time-frequency resource on a same antenna port; and the same number of transmission data layers is 2 at most or 4 at most.

That is, in response to the transmission scheme including the SFN scheme, one or more panels corresponding to the PUSCH may be configured according to the first information to map the same number of transmission data layers to the same time-frequency resource on the same antenna port. The same antenna port may be the same antenna port or a same group of antenna ports. The same number of transmission data layers may be 2 at most or 4 at most. It may be understood that since the SFN scheme requires multiple terminals in a synchronous state at different locations to send a same signal in a same frequency at a same time to realize reliable coverage of a certain service area. Therefore, in a case where the PUSCH communication is performed with the SFN scheme, among one or more panels corresponding to the PUSCH, different panels need to use the same antenna port to send the same data layer to different TRPs, and simultaneously map the same data layer to the same time-frequency resource.

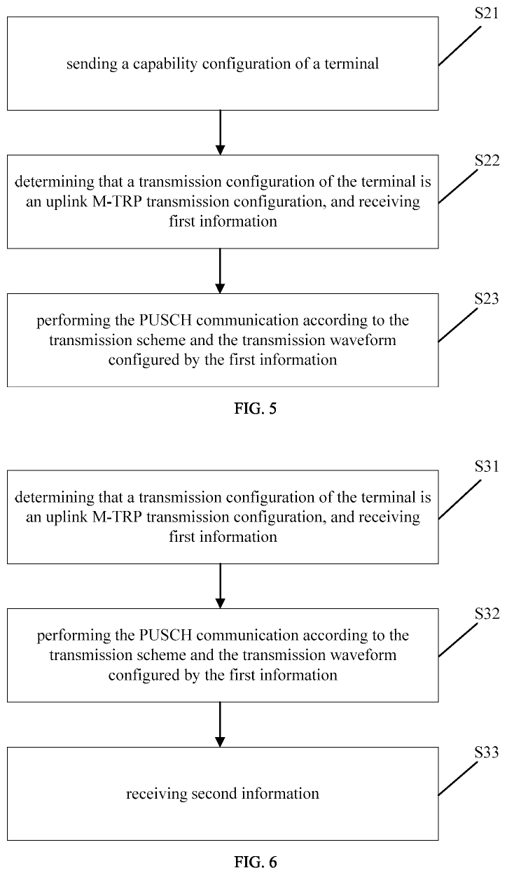

FIG. 5 is a flow chart illustrating a method for a PUSCH communication according to an illustrative embodiment. Step S22 and step S23 are the same as step S11 and step S12 in the embodiments shown in FIG. 4, and are not described again here. As shown in FIG. 5, the method includes the following steps.

In step S21, a capability configuration of a terminal is sent.

The capability configuration of the terminal is used to determine a maximum number of transmission data layers supported by each of one or more panels corresponding to a PUSCH.

In embodiments of the present disclosure, the terminal may send the capability configuration to a network device, and the network device may select a suitable configuration parameter according to the capability configuration received of the terminal, determine first information according to the suitable configuration parameter and other information, and send the first information to the terminal, such that the terminal may configure a transmission scheme and a transmission waveform according to the first information. The capability configuration of the terminal may include a same number of transmission data layers in an SFN transmission scheme, a maximum number of transmission data layers supported by each panel in an SDM transmission scheme, and/or a maximum number of transmission data layers supported by the terminal in the SDM transmission scheme.

FIG. 6 is a flow chart illustrating a method for a PUSCH communication according to an illustrative embodiment. Step S31 and step S32 are the same as step S11 and step S12 in the embodiments shown in FIG. 4, and are not described again here. As shown in FIG. 6, the method further includes the following steps.

In step S33, second information is received.

The second information is used to instruct switching a transmission scheme for a PUSCH. Further, the second information is carried in first DCI.

In embodiments of the present disclosure, the first information carried in an RRC signaling is used to configure the transmission scheme and a transmission waveform corresponding to the PUSCH in an M-TRP transmission. However, the RRC signaling is semi-static, and in a case where the transmission scheme of PUSCH needs to be switched, it may not be flexible enough to still use information carried in RRC signaling to instruct. In view of this, the second information carried in the first DCI is used to instruct switching the transmission scheme for the PUSCH.

In embodiments of the present disclosure, for the DG PUSCH, in a case where the PUSCH is scheduled according to S-DCI, dynamic switching of the transmission scheme for the PUSCH may be instructed by different code points in an SRI field in DCI.

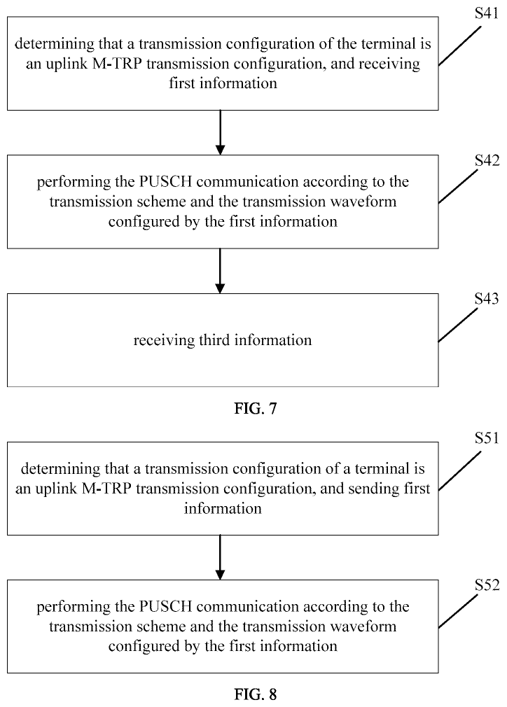

FIG. 7 is a flow chart illustrating a method for a PUSCH communication according to an illustrative embodiment. Step S41 and step S42 are the same as step S11 and step S12 in the embodiments shown in FIG. 4, and are not described again here. As shown in FIG. 7, the method further includes the following steps.

In step S43, third information is received.

The third information is used to instruct switching a transmission waveform for a PUSCH. In an example, the third information is carried in a media access control control element (MAC CE) signaling. In another example, the third information is carried in second DCI. Further, the third information is used to indicate a transmission waveform after switching.

In embodiments of the present disclosure, in order to improve the flexibility of an instruction to switch the transmission waveform, the third information carried in the MAC CE signaling or the second DCI is used to instruct switching the transmission waveform for the PUSCH. In a case where the third information carried in the MAC CE signaling is used to instruct switching the transmission waveform for the PUSCH, the PUSCH may be a CG PUSCH in an STxMP transmission or a DG PUSCH in an STxMP transmission. In a case where the third information carried in the second DCI is used to instruct switching the transmission waveform for the PUSCH, a transmission waveform indication field in DCI used to schedule an M-TRP indicates a transmission waveform or whether to perform a waveform switching. In this way, the PUSCH may be the DG PUSCH or a CG PUSCH of a type2.

In embodiments of the present disclosure, the transmission waveform indication field includes one or more bits, and different values of the one or more bits indicate different transmission waveforms; or a first value of the one or more bits indicates that the transmission waveform is switched, and a second value indicates that the transmission waveform is not switched. Taking the transmission waveform indication field in the DCI including one bit as an example, when a value of the bit is 0, the transmission waveform may be indicated to be a CP-OFDM waveform, and when the value of the bit is 1, the transmission waveform may be indicated to be a DFT-S-OFDM waveform, and vice versa. On the other hand, when the value of the bit is 0, it may be instructed not to perform a transmission waveform switching, and when the value of the bit is 1, it may be instructed to perform the transmission waveform switching, and vice versa.

In embodiments of the present disclosure, in a case where the PUSCH is scheduled according to M-DCI, PUSCHs corresponding to multiple panels scheduled by the M-DCI correspond to a same transmission waveform. In this way, the PUSCH may be a DG PUSCH or a CG PUSCH.

In embodiments of the present disclosure, the third information may include single indication information, and the single indication information jointly instructs uniformly switching the transmission waveforms for PUSCHs corresponding to different panels. In another embodiment, the third information may include multiple pieces of indication information, and the multiple pieces of indication information respectively instruct switching the transmission waveforms for the PUSCHs corresponding to different panels.

In embodiments of the present disclosure, according to an ideal backhaul condition of a PUSCH transmission link, it may be determined that the single indication information or the multiple pieces of indication information instruct switching the transmission waveforms for the PUSCHs corresponding to different panels scheduled by the M-DCI. For example, in a case where different panels scheduled by the M-DCI correspond to ideal backhaul links, the single indication information jointly instructs uniformly switching the transmission waveforms for the PUSCHs corresponding to different panels, or the multiple pieces of indication information respectively instruct switching the transmission waveforms for the PUSCHs corresponding to different panels. That is, in the case of ideal backhaul, different TRP schedules are indicated jointly by one piece of indication information or respectively by the multiple pieces of indication information. For different panels scheduled by the M-DCI correspond to non-ideal backhaul links, the multiple pieces of indication information respectively instruct switching the transmission waveforms for the PUSCHs corresponding to different panels. That is, in the case of non-ideal backhaul, different TRP schedules are indicated by the multiple pieces of indication information, respectively.

In embodiments of the present disclosure, in response to receiving the third information instructing switching the transmission waveforms for the PUSCHs corresponding to a part of the multiple panels scheduled by the M-DCI, it is determined that the third information is invalid, or the transmission waveforms is switched for the PUSCHs corresponding to all of the multiple panels scheduled by the M-DCI according to the third information.

As mentioned above, in a case where the PUSCH is scheduled according to the M-DCI, the PUSCHs corresponding to the multiple panels scheduled by the M-DCI correspond to the same transmission waveform. On this basis, in a case where the third information received by the terminal instructs switching the transmission waveforms for the PUSCHs corresponding to a part of the multiple panels scheduled by the M-DCI, if the transmission waveforms are switched only for the PUSCHs corresponding to the part of the multiple panels and the transmission waveforms are not switched for the PUSCHs corresponding to the remaining panels, the PUSCH corresponding to the multiple panels scheduled by the M-DCI after the switching will correspond to different transmission waveforms. In view of this, it is possible to ensure that the PUSCHs corresponding to the multiple panels scheduled by M-DCI still correspond to the same transmission waveform by determining that the third information instructing switching the transmission waveforms for the PUSCHs corresponding to a part of the multiple panels scheduled by the M-DCI is invalid (i.e., ignoring the third information), or switching the transmission waveforms for the PUSCHs corresponding to all of the multiple panels scheduled by the M-DCI according to the third information.

In embodiments of the present disclosure, a transmission configuration of the terminal is an M-TRP transmission configuration, and the terminal performs the PUSCH communication according to a single panel; or a transmission configuration of the terminal is an M-TRP transmission configuration, and the terminal performs the PUSCH communication with a single TRP. That is, with the technical solution provided by the embodiments of the present disclosure, the transmission configuration of the terminal is the M-TRP transmission configuration, and the terminal performs the PUSCH communication according to multiple panels, or the terminal performs the PUSCH communication with multiple TRPs. Further, with the technical solution provided by the embodiments of the present disclosure, the transmission configuration of the terminal is the M-TRP transmission configuration, and the terminal performs the PUSCH communication according to the single panel; or the terminal performs the PUSCH communication with the single TRP.

FIG. 8 is a flow chart illustrating a method for a PUSCH communication according to an illustrative embodiment. As shown in FIG. 8, the method is performed by a network device and includes the following steps.

In step S51, it is determined that a transmission configuration of a terminal is an uplink M-TRP transmission configuration, and first information is sent.

The first information is used to configure a transmission scheme and a transmission waveform corresponding to a PUSCH in an M-TRP transmission.

In step S52, the PUSCH communication is performed according to the transmission scheme and the transmission waveform configured by the first information.

In embodiments of the present disclosure, the network device may determine that the transmission configuration of the terminal is the uplink M-TRP transmission configuration. For example, the network device may configure multiple SRS resource sets for the terminal. The multiple SRS resource sets may correspond to codebook-based uplink M-TRP transmission or non-codebook-based uplink M-TRP transmission. In this case, the network device may determine that the transmission configuration of the terminal is the uplink M-TRP transmission configuration.

In embodiments of the present disclosure, the PUSCH may be a DG PUSCH or a CG PUSCH.

In embodiments of the present disclosure, in response to determining that the transmission configuration of the terminal is the uplink M-TRP transmission configuration, the network device may send the first information, and the first information is used to configure the transmission scheme and the transmission waveform corresponding to the PUSCH in the M-TRP transmission. In an example, the first information may be carried in an RRC signaling.

In the related art, in a case where the transmission configuration of the terminal is an uplink S-TRP transmission configuration, the transmission scheme corresponding to the PUSCH is indicated by DCI. For example, the DCI may indicate that the transmission scheme corresponding to the PUSCH is an SDM scheme or an SFN scheme, or the DCI may indicate that the transmission scheme corresponding to the PUSCH is switched to the SDM scheme or the SFN scheme. Further, in the related art, the transmission waveform may be configured to be a DFT-s-OFDM waveform by configuring transformPrecoder enabled by the RRC signaling, and the transmission waveform may be configured to be a CP-OFDM waveform disabled by the RRC signaling. As mentioned above, since the DFT-S-OFDM waveform is currently mainly used in a cell edge scenario, and the SDM/SFN transmission scheme may also obtain gain at a cell edge, the transmission scheme and the transmission waveform corresponding to the PUSCH in the M-TRP transmission may be indicated by unified first information. Furthermore, the transmission scheme and the transmission waveform corresponding to the PUSCH in the M-TRP transmission may be indicated by the first information carried in the RRC signaling.

In embodiments of the present disclosure, the network device may perform the PUSCH communication according to the transmission scheme and the transmission waveform configured by the first information.

By adopting the technical solution of the embodiments of the present disclosure, the network device sends the first information and configures the transmission scheme and the transmission waveform corresponding to the PUSCH in the M-TRP transmission according to the first information. Therefore, a solution for instructing and switching the transmission scheme and the transmission waveform in the STxMP transmission is provided, thereby improving the throughput and efficiency of the uplink of the system.

In embodiments of the present disclosure, the PUSCH may be scheduled according to the S-DCI or the M-DCI.

In embodiments of the present disclosure, the transmission scheme may include the SDM scheme or the SFN scheme, and the transmission waveform may be the DFT-S-OFDM waveform.

In embodiments of the present disclosure, in response to the transmission scheme including the SDM scheme, the first information is further used to configure a first transmission resource configuration parameter, and the first transmission resource configuration parameter is used to configure one or more panels corresponding to the PUSCH to map to a same time-frequency resource. The first transmission resource configuration parameter includes at least one of: a maximum number of transmission data layers supported by the terminal; or a maximum number of transmission data layers supported by each of the one or more panels corresponding to the PUSCH.

That is, in response to the transmission scheme including the SDM scheme, the maximum number of transmission data layers supported by the terminal or the maximum number of transmission data layers supported by each of the one or more panels corresponding to the PUSCH may be configured according to the first information. The maximum number of transmission data layers supported by each of the one or more panels corresponding to the PUSCH is 1 or 2. The maximum number of transmission data layers supported by the terminal is determined by the product of a number of panels corresponding to the terminal performing the uplink transmission and the maximum number of transmission data layers supported by each panel.

In an example, in a case where the terminal performs the uplink transmission according to two panels, and the maximum number of transmission data layers supported by each panel is 1, the terminal may support an SDM transmission in which the maximum number of transmission data layers is 2, and different panels are mapped to the same time-frequency resource. In another example, in a case where the terminal includes two panels, and the maximum number of transmission data layers supported by each panel is 2, the terminal may support an SDM transmission in which the maximum number of transmission data layers is 4, and different panels are mapped to the same time-frequency resource. In this way, a peak to average power ratio (PAPR) may increase, but the throughput of the system will increase.

In embodiments of the present disclosure, in response to the transmission scheme including the SFN scheme, the first information is further used to configure a second transmission resource configuration parameter. The second transmission resource configuration parameter is used to configure one or more panels corresponding to the PUSCH to map a same number of transmission data layers to a same time-frequency resource on a same antenna port; and the same number of transmission data layers is 2 at most or 4 at most.

That is, in response to the transmission scheme including the SFN scheme, one or more panels corresponding to the PUSCH may be configured according to the first information to map the same number of transmission data layers to the same time-frequency resource on the same antenna port. The same antenna port may be the same antenna port or a same group of antenna ports. The same number of transmission data layers may be 2 at most or 4 at most. It may be understood that since the SFN scheme requires multiple terminals in a synchronous state at different locations to send a same signal in a same frequency at a same time to realize reliable coverage of a certain service area. Therefore, in a case where the PUSCH communication is performed with the SFN scheme, among one or more panels corresponding to the PUSCH, different panels need to use the same antenna port to send the same data layer to different TRPs, and simultaneously map the same data layer to the same time-frequency resource.

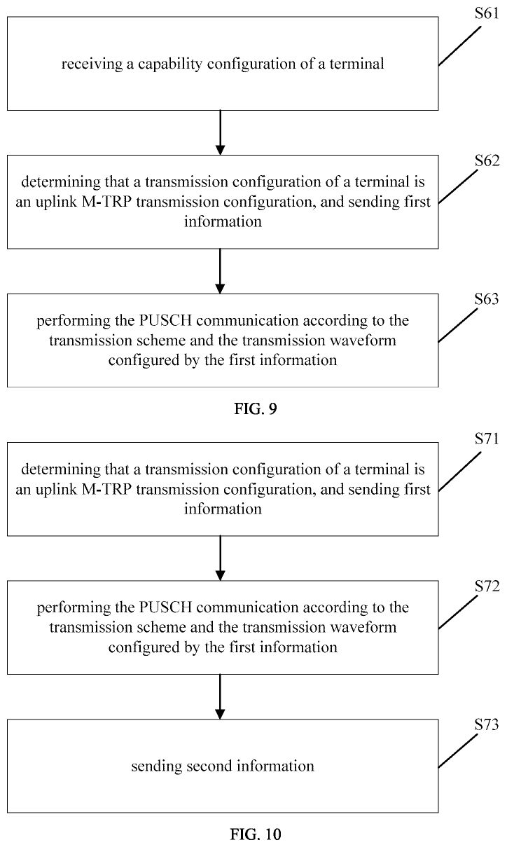

FIG. 9 is a flow chart illustrating a method for a PUSCH communication according to an illustrative embodiment. Step S62 and step S63 are the same as step S51 and step S52 in the embodiments shown in FIG. 8, and are not described again here. As shown in FIG. 9, the method includes the following steps.

In step S61, a capability configuration of a terminal is received.

The capability configuration of the terminal is used to determine a maximum number of transmission data layers supported by each of one or more panels corresponding to a PUSCH.

In embodiments of the present disclosure, a network device may receive the capability configuration sent by the terminal, and the network device may select a suitable configuration parameter according to the capability configuration received of the terminal, determine first information according to the suitable configuration parameter and other information, and send the first information to the terminal, such that the terminal may configure a transmission scheme and a transmission waveform according to the first information. The capability configuration of the terminal may include a same number of transmission data layers in an SFN transmission scheme, a maximum number of transmission data layers supported by each panel in an SDM transmission scheme, and/or a maximum number of transmission data layers supported by the terminal in the SDM transmission scheme.

FIG. 10 is a flow chart illustrating a method for a PUSCH communication according to an illustrative embodiment. Step S71 and step S72 are the same as step S51 and step S52 in the embodiments shown in FIG. 8, and are not described again here. As shown in FIG. 10, the method further includes the following steps.

In step S73, second information is sent.

The second information is used to instruct switching a transmission scheme for a PUSCH. Further, the second information is carried in first DCI.

In embodiments of the present disclosure, the first information carried in an RRC signaling is used to configure the transmission scheme and a transmission waveform corresponding to the PUSCH in an M-TRP transmission. However, the RRC signaling is semi-static, and in a case where the transmission scheme of PUSCH needs to be switched, it may not be flexible enough to still use information carried in RRC signaling to instruct. In view of this, the second information carried in the first DCI is used to instruct switching the transmission scheme for the PUSCH.

In embodiments of the present disclosure, for the DG PUSCH, in a case where the PUSCH is scheduled according to S-DCI, dynamic switching of the transmission scheme for the PUSCH may be instructed by different code points in an SRI field in DCI.

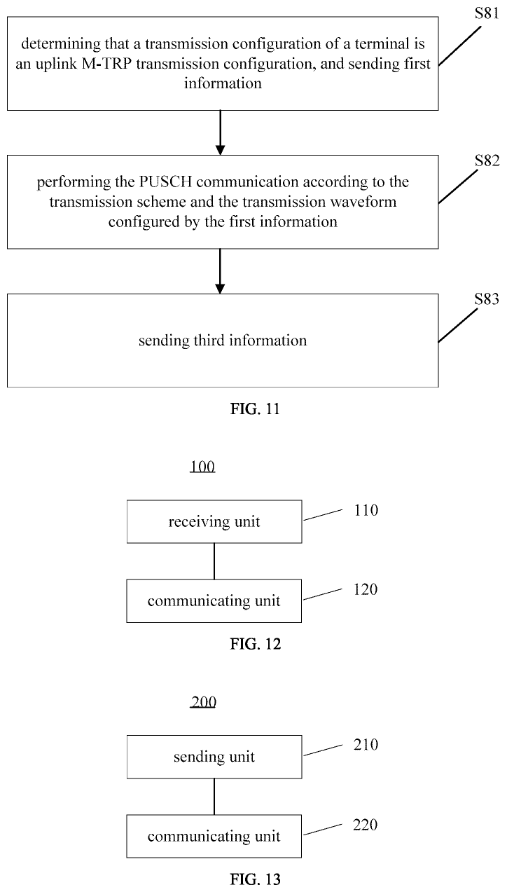

FIG. 11 is a flow chart illustrating a method for a PUSCH communication according to an illustrative embodiment. Step S81 and step S82 are the same as step S51 and step S52 in the embodiments shown in FIG. 8, and are not described again here. As shown in FIG. 117, the method further includes the following steps.

In step S83, third information is sent.

The third information is used to instruct switching a transmission waveform for a PUSCH. In an example, the third information is carried in a media access control control element (MAC CE) signaling. In another example, the third information is carried in second DCI. Further, the third information is used to indicate a transmission waveform after switching.

In embodiments of the present disclosure, in order to improve the flexibility of an instruction to switch the transmission waveform, the third information carried in the MAC CE signaling or the second DCI is used to instruct switching the transmission waveform for the PUSCH. In a case where the third information carried in the MAC CE signaling is used to instruct switching the transmission waveform for the PUSCH, the PUSCH may be a CG PUSCH in an STxMP transmission or a DG PUSCH in an STxMP transmission. In a case where the third information carried in the second DCI is used to instruct switching the transmission waveform for the PUSCH, a transmission waveform indication field in DCI used to schedule an M-TRP indicates a transmission waveform or whether to perform a waveform switching. In this way, the PUSCH may be the DG PUSCH or a CG PUSCH of a type2.

In embodiments of the present disclosure, the transmission waveform indication field includes one or more bits, and different values of the one or more bits indicate different transmission waveforms; or a first value of the one or more bits indicates that the transmission waveform is switched, and a second value indicates that the transmission waveform is not switched. Taking the transmission waveform indication field in the DCI including one bit as an example, when a value of the bit is 0, the transmission waveform may be indicated to be a CP-OFDM waveform, and when the value of the bit is 1, the transmission waveform may be indicated to be a DFT-S-OFDM waveform, and vice versa. On the other hand, when the value of the bit is 0, it may be instructed not to perform a transmission waveform switching, and when the value of the bit is 1, it may be instructed to perform the transmission waveform switching, and vice versa.

In embodiments of the present disclosure, in a case where the PUSCH is scheduled according to M-DCI, PUSCHs corresponding to multiple panels scheduled by the M-DCI correspond to a same transmission waveform. In this way, the PUSCH may be a DG PUSCH or a CG PUSCH.

In embodiments of the present disclosure, the third information may include single indication information, and the single indication information jointly instructs uniformly switching the transmission waveforms for PUSCHs corresponding to different panels. In another embodiment, the third information may include multiple pieces of indication information, and the multiple pieces of indication information respectively instruct switching the transmission waveforms for the PUSCHs corresponding to different panels.

In embodiments of the present disclosure, according to an ideal backhaul condition of a PUSCH transmission link, it may be determined that the single indication information or the multiple pieces of indication information instruct switching the transmission waveforms for the PUSCHs corresponding to different panels scheduled by the M-DCI. For example, in a case where different panels scheduled by the M-DCI correspond to ideal backhaul links, the single indication information jointly instructs uniformly switching the transmission waveforms for the PUSCHs corresponding to different panels, or the multiple pieces of indication information respectively instruct switching the transmission waveforms for the PUSCHs corresponding to different panels. That is, in the case of ideal backhaul, different TRP schedules are indicated jointly by one piece of indication information or respectively by the multiple pieces of indication information. For different panels scheduled by the M-DCI correspond to non-ideal backhaul links, the multiple pieces of indication information respectively instruct switching the transmission waveforms for the PUSCHs corresponding to different panels. That is, in the case of non-ideal backhaul, different TRP schedules are indicated by the multiple pieces of indication information, respectively.

In embodiments of the present disclosure, in response to that the third information instructs switching the transmission waveforms for the PUSCHs corresponding to a part of the multiple panels scheduled by the M-DCI, it is determined that the third information is invalid, or the transmission waveforms is switched for the PUSCHs corresponding to all of the multiple panels scheduled by the M-DCI according to the third information.

As mentioned above, in a case where the PUSCH is scheduled according to the M-DCI, the PUSCHs corresponding to the multiple panels scheduled by the M-DCI correspond to the same transmission waveform. On this basis, in a case where the third information sent by the network device instructs switching the transmission waveforms for the PUSCHs corresponding to a part of the multiple panels scheduled by the M-DCI, if the transmission waveforms are switched only for the PUSCHs corresponding to the part of the multiple panels and the transmission waveforms are not switched for the PUSCHs corresponding to the remaining panels, the PUSCH corresponding to the multiple panels scheduled by the M-DCI after the switching will correspond to different transmission waveforms. In view of this, it is possible to ensure that the PUSCHs corresponding to the multiple panels scheduled by M-DCI still correspond to the same transmission waveform by determining that the third information instructing switching the transmission waveforms for the PUSCHs corresponding to a part of the multiple panels scheduled by the M-DCI is invalid (i.e., ignoring the third information), or switching the transmission waveforms for the PUSCHs corresponding to all of the multiple panels scheduled by the M-DCI according to the third information.

In embodiments of the present disclosure, a transmission configuration of the terminal is an M-TRP transmission configuration, and the terminal performs the PUSCH communication according to a single panel; or a transmission configuration of the terminal is an M-TRP transmission configuration, and the terminal performs the PUSCH communication with a single TRP. That is, with the technical solution provided by the embodiments of the present disclosure, the transmission configuration of the terminal is the M-TRP transmission configuration, and the terminal performs the PUSCH communication according to multiple panels, or the terminal performs the PUSCH communication with multiple TRPs. Further, with the technical solution provided by the embodiments of the present disclosure, the transmission configuration of the terminal is the M-TRP transmission configuration, and the terminal performs the PUSCH communication according to the single panel; or the terminal performs the PUSCH communication with the single TRP.

It may be understood that the technical implementation involved in a process for the PUSCH communication performed by the network device in embodiments of the present disclosure may be applied to a process for the PUSCH communication performed by the terminal in embodiments of the present disclosure. Therefore, regarding some technical implementations of the process for the PUSCH communication performed by the network device that are not described in detail, please refer to the relevant description of the process for the PUSCH communication performed by the terminal, which is not repeated in the present disclosure.

It may be understood that the method for the PUSCH communication provided in embodiments of the present disclosure is applicable to the process for the PUSCH communication during an interaction process between the terminal and the network device. Regarding a process of an interaction between the terminal and the network device to realize the PUSCH communication, which is not repeated in the present disclosure.

It should be noted that those skilled in the art will appreciate that the various implementations/examples in above embodiments of the present disclosure may be used in conjunction with the foregoing embodiments or may be used independently. The principles of the various implementations/examples are similar, whether used alone or in conjunction with the foregoing embodiments. In an implementation of the present disclosure, some embodiments are described as embodiments that are used together. Certainly, it will be understood by those skilled in the art that such illustrations are not intended to limit the embodiments of the present disclosure.

Based on the same concept, embodiments of the present disclosure also provide an apparatus for a PUSCH communication.

It may be understood that, the apparatus for the PUSCH communication provided by the embodiments of the present disclosure includes corresponding hardware structures and/or software modules for performing various functions in order to implement the above-mentioned functions. The embodiments of the present disclosure may be implemented in a form of hardware or a combination of hardware and computer software in combination with units and algorithm steps of each example disclosed in the embodiments of the present disclosure. Whether a function is performed by hardware or by hardware driven by computer software depends on specific applications and design constraints of the technical solution. Those skilled in the art may use different methods to implement the described functions for each specific application, but such an implementation should not be regarded as extending beyond the scope of the technical solutions of the embodiments of the present disclosure.

FIG. 12 is a block diagram illustrating an apparatus for a PUSCH communication according to an illustrative embodiment. Referring to FIG. 12, the apparatus 100 includes a receiving unit 110 and a communicating unit 120.

The receiving unit 110 is configured to determine that a transmission configuration of the terminal is an uplink M-TRP transmission configuration, and receive first information.

The first information is used to configure a transmission scheme and a transmission waveform corresponding to a PUSCH in an M-TRP transmission.

The communicating unit 120 is configured to perform the PUSCH communication according to the transmission scheme and the transmission waveform configured by the first information.

In embodiments of the present disclosure, the transmission scheme includes an SDM scheme or an SFN scheme.

In embodiments of the present disclosure, in response to the transmission scheme including the SDM scheme, the first information is further used to configure a first transmission resource configuration parameter, and the first transmission resource configuration parameter is used to configure one or more panels corresponding to the PUSCH to map to a same time-frequency resource; and the first transmission resource configuration parameter includes at least one of: a maximum number of transmission data layers supported by the terminal; or a maximum number of transmission data layers supported by each of the one or more panels corresponding to the PUSCH.

In embodiments of the present disclosure, the maximum number of transmission data layers supported by each of the one or more panels corresponding to the PUSCH is 1 or 2.

In embodiments of the present disclosure, in response to the transmission scheme including the SFN scheme, the first information is further used to configure a second transmission resource configuration parameter; the second transmission resource configuration parameter is used to configure one or more panels corresponding to the PUSCH to map a same number of transmission data layers to a same time-frequency resource on a same antenna port; and the same number of transmission data layers is 2 at most or 4 at most.

In embodiments of the present disclosure, the method further includes: sending a capability configuration of the terminal, in which the capability configuration of the terminal is used to determine the maximum number of transmission data layers supported by each of the one or more panels corresponding to the PUSCH.

In embodiments of the present disclosure, the transmission waveform is a DFT-S-OFDM waveform.

In embodiments of the present disclosure, the method further includes: receiving second information, in which the second information is used to instruct switching the transmission scheme for the PUSCH.

In embodiments of the present disclosure, the second information is carried in first DCI.

In embodiments of the present disclosure, the method further includes: receiving third information, in which the third information is used to instruct switching the transmission waveform for the PUSCH.

In embodiments of the present disclosure, the third information is carried in an MAC CE signaling and used to indicate a transmission waveform after switching.

In embodiments of the present disclosure, the third information is carried in second DCI, and the second DCI is used to schedule an M-TRP and includes a transmission waveform indication field for indicating a transmission waveform or whether to perform a waveform switching.

In embodiments of the present disclosure, the transmission waveform indication field includes one or more bits, and different values of the one or more bits indicate different transmission waveforms; or a first value of the one or more bits indicates that the transmission waveform is switched, and a second value indicates that the transmission waveform is not switched.

In embodiments of the present disclosure, the PUSCH is scheduled according to S-DCI.

In embodiments of the present disclosure, the PUSCH is scheduled according to M-DCI; and PUSCHs corresponding to multiple panels scheduled by the M-DCI correspond to a same transmission waveform.

In embodiments of the present disclosure, the third information includes single indication information, and the single indication information jointly instructs uniformly switching the transmission waveforms for PUSCHs corresponding to different panels; or the third information includes multiple pieces of indication information, and the multiple pieces of indication information respectively instruct switching the transmission waveforms for PUSCHs corresponding to different panels.

In embodiments of the present disclosure, in response to receiving the third information instructing switching the transmission waveforms for the PUSCHs corresponding to a part of the multiple panels scheduled by the M-DCI, determining that the third information is invalid, or switching the transmission waveforms for the PUSCHs corresponding to all of the multiple panels scheduled by the M-DCI according to the third information.

In embodiments of the present disclosure, the transmission configuration of the terminal is the M-TRP transmission configuration, and the terminal performs the PUSCH communication according to a single panel; or the transmission configuration of the terminal is the M-TRP transmission configuration, and the terminal performs the PUSCH communication with a single TRP.

By adopting the technical solution of the embodiments of the present disclosure, the terminal receives the first information and configures the transmission scheme and the transmission waveform corresponding to the PUSCH in the M-TRP transmission according to the first information. Therefore, a solution for instructing and switching the transmission scheme and the transmission waveform in the STxMP transmission is provided, thereby improving the throughput and efficiency of the uplink of the system.

FIG. 13 is a block diagram illustrating an apparatus for a PUSCH communication according to an illustrative embodiment. Referring to FIG. 13, the apparatus 200 includes a sending unit 210 and a communicating unit 220.

The sending unit 210 is configured to determine that a transmission configuration of a terminal is an uplink M-TRP transmission configuration, and send first information.

The first information is used to configure a transmission scheme and a transmission waveform corresponding to a PUSCH in an M-TRP transmission.

The communicating unit 220 is configured to perform the PUSCH communication according to the transmission scheme and the transmission waveform configured by the first information.

In embodiments of the present disclosure, the transmission scheme includes an SDM scheme or an SFN scheme.

In embodiments of the present disclosure, in response to the transmission scheme including the SDM scheme, the first information is further used to configure a first transmission resource configuration parameter, and the first transmission resource configuration parameter is used to configure one or more panels corresponding to the PUSCH to map to a same time-frequency resource; and the first transmission resource configuration parameter includes at least one of: a maximum number of transmission data layers supported by the terminal; or a maximum number of transmission data layers supported by each of the one or more panels corresponding to the PUSCH.

In embodiments of the present disclosure, the maximum number of transmission data layers supported by each of the one or more panels corresponding to the PUSCH is 1 or 2.

In embodiments of the present disclosure, in response to the transmission scheme including the SFN scheme, the first information is further used to configure a second transmission resource configuration parameter; the second transmission resource configuration parameter is used to configure one or more panels corresponding to the PUSCH to map a same number of transmission data layers to a same time-frequency resource on a same antenna port; and the same number of transmission data layers is 2 at most or 4 at most.

In embodiments of the present disclosure, the method further includes: receiving a capability configuration of the terminal, in which the capability configuration of the terminal is used to determine the maximum number of transmission data layers supported by each of the one or more panels corresponding to the PUSCH.

In embodiments of the present disclosure, the transmission waveform is a DFT-S-OFDM waveform.

In embodiments of the present disclosure, the method further includes: sending second information, in which the second information is used to instruct switching the transmission scheme for the PUSCH.

In embodiments of the present disclosure, the second information is carried in first DCI.

In embodiments of the present disclosure, the method further includes: sending third information, in which the third information is used to instruct switching the transmission waveform for the PUSCH.

In embodiments of the present disclosure, the third information is carried in an MAC CE signaling and used to indicate a transmission waveform after switching.

In embodiments of the present disclosure, the third information is carried in second DCI, and the second DCI is used to schedule an M-TRP and includes a transmission waveform indication field for indicating a transmission waveform or whether to perform a waveform switching.

In embodiments of the present disclosure, the transmission waveform indication field includes one or more bits, and different values of the one or more bits indicate different transmission waveforms; or
a first value of the one or more bits indicates that the transmission waveform is switched, and a second value indicates that the transmission waveform is not switched.

In embodiments of the present disclosure, the PUSCH is scheduled according to S-DCI.

In embodiments of the present disclosure, the PUSCH is scheduled according to M-DCI; and PUSCHs corresponding to multiple panels scheduled by the M-DCI correspond to a same transmission waveform.

In embodiments of the present disclosure, the third information includes single indication information, and the single indication information jointly instructs uniformly switching the transmission waveforms for PUSCHs corresponding to different panels; or the third information includes multiple pieces of indication information, and the multiple pieces of indication information respectively instruct switching the transmission waveforms for PUSCHs corresponding to different panels.

In embodiments of the present disclosure, in response to that the third information instructs switching the transmission waveforms for the PUSCHs corresponding to a part of the multiple panels scheduled by the M-DCI, determining that the third information is invalid, or switching the transmission waveforms for the PUSCHs corresponding to all of the multiple panels scheduled by the M-DCI according to the third information.

In embodiments of the present disclosure, the transmission configuration of the terminal is the M-TRP transmission configuration, and the terminal performs the PUSCH communication according to a single panel; or the transmission configuration of the terminal is the M-TRP transmission configuration, and the terminal performs the PUSCH communication with a single TRP.

By adopting the technical solution of the embodiments of the present disclosure, the network device sends the first information and configures the transmission scheme and the transmission waveform corresponding to the PUSCH in the M-TRP transmission according to the first information. Therefore, a solution for instructing and switching the transmission scheme and the transmission waveform in the STxMP transmission is provided, thereby improving the throughput and efficiency of the uplink of the system.

With respect to the apparatus in the above embodiments, the specific manners for performing operations for individual modules therein have been described in detail in the embodiments regarding the method, which will not be elaborated herein.

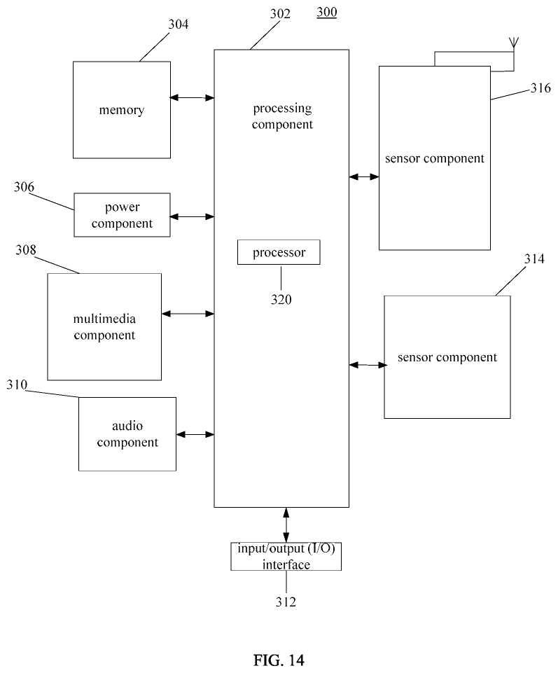

FIG. 14 is a block diagram illustrating a device 300 for a PUSCH communication according to an illustrative embodiment. For example, the device 300 may be a mobile phone, a computer, a digital broadcast terminal, a messaging device, a game console, a tablet device, a medical device, a fitness device, a personal digital assistant, or the like.

Referring to FIG. 14, the device 300 may include one or more of the following components: a processing component 302, a memory 304, a power component 306, a multimedia component 308, an audio component 310, an input/output (I/O) interface 312, a sensor component 314, and a communication component 316.

The processing component 302 typically controls overall operations of the device 300, such as the operations associated with display, phone calls, data communications, camera operations, and recording operations. The processing component 302 may include one or more processors 320 to execute instructions to perform all or some of the steps in the above-described methods. Moreover, the processing component 302 may include one or more modules which facilitate the interaction between the processing component 302 and other components. For instance, the processing component 302 may include a multimedia module to facilitate the interaction between the multimedia component 308 and the processing component 302.

The memory 304 is configured to store various types of data to support the operation of the device 300. Examples of such data include instructions for any applications or methods operated on the device 300, contact data, phonebook data, messages, pictures, videos, etc. The memory 304 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 306 provides power to various components of the device 300. The power component 306 may include a power management system, one or more power sources, and any other components associated with the generation, management, and distribution of power in the device 300.

The multimedia component 308 includes a screen providing an output interface between the device 300 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 308 includes a front camera and/or a rear camera. The front camera and/or the rear camera may receive an external multimedia datum while the device 300 is in an operation mode, such as a photographing mode or a video mode. Each of the front camera and the rear camera may be a fixed optical lens system or have focus and optical zoom capability.

The audio component 310 is configured to output and/or input audio signals. For example, the audio component 310 includes a microphone (MIC) configured to receive an external audio signal when the device 300 is in an operation mode, such as a call mode, a recording mode, and a voice recognition mode. The received audio signal may be further stored in the memory 304 or transmitted via the communication component 316. In some embodiments, the audio component 310 further includes a speaker to output audio signals.

The I/O interface 312 provides an interface between the processing component 302 and peripheral interface modules, such as keyboards, click wheels, buttons, and the like. The buttons may include, but are not limited to, a home button, a volume button, a starting button, and a locking button.

The sensor component 314 includes one or more sensors to provide status assessments of various aspects of the device 300. For instance, the sensor component 314 may detect an open/closed status of the device 300, relative positioning of components, e.g., the display and the keypad, of the device 300, a change in position of the device 300 or a component of the device 300, a presence or absence of user contact with the device 300, an orientation or an acceleration/deceleration of the device 300, and a change in temperature of the device 300. The sensor component 314 may include a proximity sensor configured to detect the presence of nearby objects without any physical contact. The sensor component 314 may further include a light sensor, such as a CMOS or CCD image sensor, for use in imaging applications. In some embodiments, the sensor component 314 may further include an accelerometer sensor, a gyroscope sensor, a magnetic sensor, a pressure sensor, or a temperature sensor.

The communication component 316 is configured to facilitate communication, wired or wireless, between the device 300 and other devices. The device 300 may access a wireless network based on a communication standard, such as Wi-Fi, 2G, or 3G, or a combination thereof. In an illustrative embodiment, the communication component 316 receives a broadcast signal or broadcast associated information from an external broadcast management system via a broadcast channel. In an illustrative embodiment, the communication component 316 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In an illustrative embodiment, the device 300 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic elements, for performing the above-mentioned methods.

In an illustrative embodiment, there is also provided a non-transitory computer-readable storage medium including instructions, such as included in the memory 304, executable by the processor 320 in the device 300, for completing the above-mentioned methods. For example, the non-transitory computer-readable storage medium may be a ROM, a random access memory (RAM), a CD-ROM, a magnetic tape, a floppy disc, an optical data storage device, and the like.

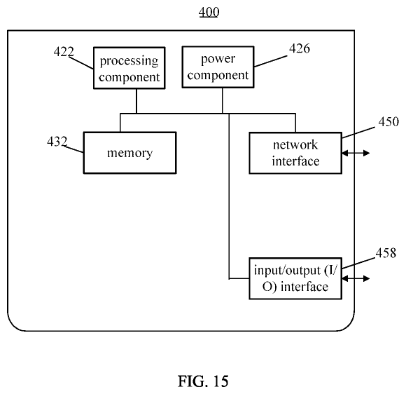

FIG. 15 is a block diagram illustrating a device 400 for a PUSCH communication according to an illustrative embodiment. For example, the device 400 may be provided as a server. Referring to FIG. 15, the device 400 includes a processing component 422 and a memory resource represented by a memory 432. The processing component 422 may further include one or more processors. The memory 432 is configured to store instructions executable by the processing component 422, such as an application program. The application program stored in the memory 432 may include one or more modules each corresponding to a set of instructions. In addition, the processing component 422 is configured to execute the instructions to perform the methods for configuring the TCI state.

The device 400 further includes a power component 426 configured to perform power management on the device 400, a wired or wireless network interface 450 configured to connect the device 400 to the network, and an input/output (I/O) interface 458. The device 400 may operate an operating system stored in the memory 432, such as Windows Server™, Mac OS X™, Unix™, Linux™, Free BSD™, or the like.

It is further understood that “a plurality” in this disclosure refers to two or more, and other quantifiers are similar thereto. “And/or”, which describes an associated relationship of associated objects, means that there may be three relationships, for example, A and/or B, which may mean that A exists alone, A and B exist at the same time, and B exists alone. A character “/” generally indicates that contextual objects are in an “or” relationship. “A/an” and “the” in singular forms are intended to include plural forms, unless clearly indicated in the context otherwise.

It is further understood that the meaning of terms such as “in response to”, “if”, and the like involved in the present disclosure will depend on the context and the actual use scenario. As used herein, the term “in response to” may be construed to mean “when” or “upon” or “if” or “in a case where” depending on the context.

It is further understood that terms such as “first”, and “second” are used to describe various information, these information should not be limited by these terms. These terms are only used for distinguishing information of the same type from each other and do not denote a particular order or degree of importance. As a matter of fact, the terms such as “first”, and “second” may be used interchangeably. For example, first information may also be referred to as second information, and similarly, the second information may also be referred to as the first information, without departing from the scope of embodiments of the present disclosure.

It is further understood that although operations are described in a specific order in the accompanying drawings in the embodiments of the present disclosure, it should not be understood that these operations are required to be performed in the specific order shown or in a serial order, or that all of the operations shown are required to be performed to obtain desired results. In certain circumstances, multitasking and parallel processing may be advantageous.

Other embodiments of the present disclosure will be apparent to those skilled in the art from consideration of the specification and practice of the present disclosure disclosed here. The present disclosure is intended to cover any variations, uses, or adaptations of the present disclosure following the general principles thereof and including such departures from the present disclosure as come within known or customary practice in the art.

It will be appreciated that the present disclosure is not limited to the exact construction that has been described above and illustrated in the accompanying drawings, and that various modifications and changes can be made without departing from the scope thereof. It is intended that the scope of the present disclosure only be limited by the appended claims.

1. A method for a physical uplink shared channel (PUSCH) communication, performed by a terminal, comprising:
determining that a transmission configuration of the terminal is an uplink multiple-transmission reception point (M-TRP) transmission configuration, and receiving first information, wherein the first information is used to configure a transmission scheme and a transmission waveform corresponding to a PUSCH in an M-TRP transmission; and
performing the PUSCH communication according to the transmission scheme and the transmission waveform configured by the first information.

2. The method according to claim 1, wherein the transmission scheme comprises a space division multiplexing (SDM) scheme or a single frequency network (SFN) scheme.

3. The method according to claim 2, wherein in response to the transmission scheme comprising the SDM scheme, the first information is further used to configure a first transmission resource configuration parameter, and the first transmission resource configuration parameter is used to configure one or more panels corresponding to the PUSCH to map to a same time-frequency resource; and
the first transmission resource configuration parameter comprises at least one of:
a maximum number of transmission data layers supported by the terminal; or
a maximum number of transmission data layers supported by each of the one or more panels corresponding to the PUSCH.

4. (canceled)

5. The method according to claim 2, wherein in response to the transmission scheme comprising the SFN scheme, the first information is further used to configure a second transmission resource configuration parameter;
the second transmission resource configuration parameter is used to configure one or more panels corresponding to the PUSCH to map a same number of transmission data layers to a same time-frequency resource on a same antenna port; and
the same number of transmission data layers is 2 at most or 4 at most.

6-7. (canceled)

8. The method according to claim 1, further comprising:
receiving second information, wherein the second information is used to instruct switching the transmission scheme for the PUSCH.

9. The method according to claim 8, wherein the second information is carried in first downlink control information (DCI).

10. The method according to claim 1, further comprising:
receiving third information, wherein the third information is used to instruct switching the transmission waveform for the PUSCH.

11. The method according to claim 10, wherein the third information is carried in a media access control control element (MAC CE) signaling and used to indicate a transmission waveform after switching.

12. The method according to claim 10, wherein the third information is carried in second DCI, and the second DCI is used to schedule an M-TRP and comprises a transmission waveform indication field for indicating a transmission waveform or whether to perform a waveform switching,
wherein the transmission waveform indication field comprises one or more bits, and different values of the one or more bits indicate different transmission waveforms; or
a first value of the one or more bits indicates that the transmission waveform is switched, and a second value indicates that the transmission waveform is not switched.

13-18. (canceled)

19. A method for a physical uplink shared channel (PUSCH) communication, performed by a network device, comprising:
determining that a transmission configuration of a terminal is an uplink multiple-transmission reception point (M-TRP) transmission configuration, and sending first information, wherein the first information is used to configure a transmission scheme and a transmission waveform corresponding to a PUSCH in an M-TRP transmission; and
performing the PUSCH communication according to the transmission scheme and the transmission waveform configured by the first information.

20. The method according to claim 19, wherein the transmission scheme comprises a space division multiplexing (SDM) scheme or a single frequency network (SFN) scheme.

21. The method according to claim 20, wherein in response to the transmission scheme comprising the SDM scheme, the first information is further used to configure a first transmission resource configuration parameter, and the first transmission resource configuration parameter is used to configure one or more panels corresponding to the PUSCH to map to a same time-frequency resource; and
the first transmission resource configuration parameter comprises at least one of:
a maximum number of transmission data layers supported by the terminal; or
a maximum number of transmission data layers supported by each of the one or more panels corresponding to the PUSCH.

22. (canceled)

23. The method according to claim 20, wherein in response to the transmission scheme comprising the SFN scheme, the first information is further used to configure a second transmission resource configuration parameter;
the second transmission resource configuration parameter is used to configure one or more panels corresponding to the PUSCH to map a same number of transmission data layers to a same time-frequency resource on a same antenna port; and
the same number of transmission data layers is 2 at most or 4 at most.

24-25. (canceled)

26. The method according to claim 19, further comprising:
sending second information, wherein the second information is used to instruct switching the transmission scheme for the PUSCH.

27. The method according to claim 26, wherein the second information is carried in first downlink control information (DCI).

28. The method according to claim 19, further comprising:
sending third information, wherein the third information is used to instruct switching the transmission waveform for the PUSCH.

29. The method according to claim 28, wherein the third information is carried in a media access control control element (MAC CE) signaling and used to indicate a transmission waveform after switching.

30. The method according to claim 28, wherein the third information is carried in second DCI, and the second DCI is used to schedule an M-TRP and comprises a transmission waveform indication field for indicating a transmission waveform or whether to perform a waveform switching,
wherein the transmission waveform indication field comprises one or more bits, and different values of the one or more bits indicate different transmission waveforms; or
a first value of the one or more bits indicates that the transmission waveform is switched, and a second value indicates that the transmission waveform is not switched.

31-38. (canceled)

39. A terminal, comprising:
a processor; and
a memory storing instructions executable by the processor,
wherein the processor is configured to:
determine that a transmission configuration of the terminal is an uplink multiple-transmission reception point (M-TRP) transmission configuration, and receiving first information, wherein the first information is used to configure a transmission scheme and a transmission waveform corresponding to a PUSCH in an M-TRP transmission; and
perform the PUSCH communication according to the transmission scheme and the transmission waveform configured by the first information.

40. (canceled)

41. A network device, comprising:
a processor; and
a memory storing instructions executable by the processor,
wherein the processor is configured to perform the method according to claim 19.
